(19) United States
(12) Patent Application Publication
(10) Pub. No.: US 2013/0003831 A1
(43) Pub. Date: Jan. 3, 2013

(54) RECEIVING APPARATUS, RECEIVING METHOD, AND PROGRAM

(75) Inventors: HIROSHI ADACHI, Chiba (JP); YUTAKA SONODA, Tokyo (JP)

(73) Assignee: Sony Corporation, Tokyo (JP)

(21) Appl. No.: 13/484,713

(22) Filed: May 31, 2012

(30) Foreign Application Priority Data
Jun. 28, 2011 (JP) 2011-142505

(51) Int. Cl. H04N 7/32

(52) U.S. Cl. 375/240.12; 375/E07.243

(57) ABSTRACT

A receiving apparatus includes a receiving unit, a buffer, an I picture detection unit, and a decoding control unit. The receiving unit is configured to receive a digital broadcasting signal including AV streams of a plurality of channels. The buffer is configured to store video stream signals acquired from the received digital broadcasting signal. The I picture detection unit is configured to detect I pictures contained in the stored video stream signals. The decoding control unit is configured to control decoding of the video stream signals in such a manner as to be successively performed in an order of time positions from the video stream signal containing the I picture located in a front position as a relative time position among the I pictures detected for the respective channels.

### BACKGROUND

The present disclosure relates to a receiving apparatus, a receiving method, and a program, and in particular, to a receiving apparatus, a receiving method, and a program that allow video of a plurality of channels to be quickly displayed on a screen.

In recent years, digital broadcasting receiving apparatuses have become widespread with the practical use of digital broadcasting using ground waves (see, for example, Japanese Patent Application Laid-open No. 2009-118352).

Digital broadcasting allows a plurality of AV streams to be multiplexed together, which makes it possible to operate a plurality of channels with one frequency band. Accordingly, some digital broadcasting receiving apparatuses have the function of displaying video of a plurality of channels on a screen so that a viewer is allowed to select a desired one of the channels.

### SUMMARY

However, in the related art, when video of a plurality of channels is displayed on a screen, video stream signals of the channels are successively decoded in the order of streams, which may take time for displaying the video of all the channels.

Therefore, in displaying video of a plurality of channels on a screen, there is a demand for quickly displaying the video of all the channels. The present disclosure has been made in view of the above circumstances, and it is therefore desirable to quickly display video of a plurality of channels on a screen.

According to an embodiment of the present disclosure, there is provided a receiving apparatus including a receiving unit, a buffer, an I (Intra-coded) picture detection unit, and a decoding control unit. The receiving unit is configured to receive a digital broadcasting signal including AV (audio/video) streams of a plurality of channels. The buffer is configured to store video stream signals acquired from the received digital broadcasting signal. The I picture detection unit is configured to detect I pictures contained in the stored video stream signals. The decoding control unit is configured to control decoding of the video stream signals in such a manner as to be successively performed in an order of time positions from the video stream signal containing the I picture located in a front position as a relative time position among the I pictures detected for the respective channels.

The receiving apparatus may further include a storage unit configured to store a table storing time information on the relative time positions of the I pictures detected for the respective channels. In the receiving apparatus, the decoding control unit may be configured to control, based on the time information stored in the table, an order of decoding the video stream signals for the respective channels.

The time positions may be specified by one of a DTS (Decoding Time Stamp) and a PTS (Presentation Time Stamp).

The table may be configured to store, as decoding control information for the respective channels, at least the time information, identification information used to identify the video stream signals, and address information on the I pictures stored in the buffer.

The decoding control unit may be configured to switch, when the video stream signal of a predetermined one of the channels is stored in the buffer by a data amount with which the decoding is allowed to be performed, the video stream signal to be stored in the buffer to the video stream signal of another of the channels.

The receiving apparatus may further include a decoder configured to decode the video stream signals supplied from the buffer and an image processing unit configured to resize video signals of the respective channels acquired by decoding the video stream signals to combine video of the channels together so as to be displayed on a screen.

The receiving apparatus may be a standalone apparatus or an internal block configuring an apparatus.

According to another embodiment of the present disclosure, there is provided a receiving method or a program corresponding to the receiving apparatus according to the embodiment of the present disclosure described above.

With the receiving apparatus, the receiving method, and the program according to an embodiment of the present disclosure, a digital broadcasting signal including AV streams of a plurality of channels is received, video stream signals acquired from the received digital broadcasting signal are stored, I pictures contained in the video stream signals are detected, and decoding of the video stream signals is controlled in such a manner as to be successively performed in the order of time positions from the video stream signal containing the I picture located in the front position as a relative time position among the I pictures detected for the respective channels.

According to an embodiment of the present disclosure, it is possible to quickly display video of a plurality of channels on a screen.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing the appearance of a digital broadcasting receiving apparatus;

FIG. 2 is a diagram showing a configuration example of the digital broadcasting receiving apparatus;

FIG. 3 is a diagram showing a detailed configuration example of a video signal processing unit;

FIG. 4 is a flowchart for explaining processing for displaying video of a plurality of channels on a screen;

FIG. 5 is a flowchart for explaining decoding control processing in detail;

FIG. 6 is a diagram showing an example of a management table;

FIG. 7 is a diagram for explaining processing time when the decoding control processing is performed; and

FIG. 8 is a diagram showing a configuration example of a computer.

### DETAILED DESCRIPTION OF EMBODIMENT

Hereinafter, an embodiment of the present disclosure will be described with reference to the drawings.

(Appearance of Digital Broadcasting Receiving Apparatus)

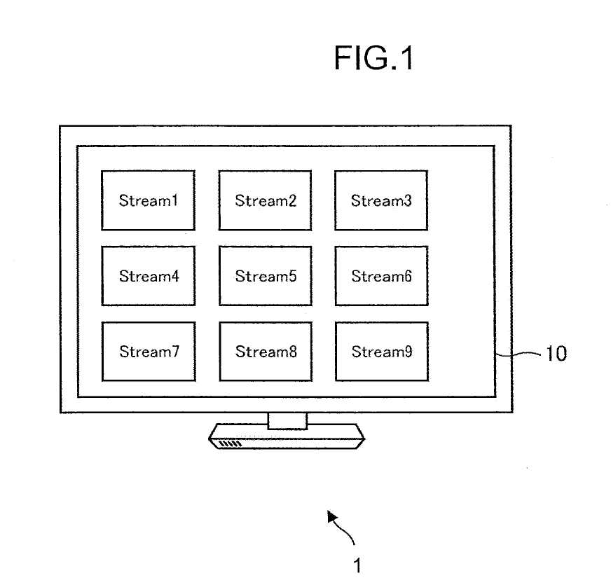

FIG. 1 is a diagram showing the appearance of a digital broadcasting receiving apparatus.

The digital broadcasting receiving apparatus 1 is a receiving apparatus capable of receiving a digital broadcasting signal that is transmitted from a broadcasting apparatus (not shown) provided on the side of a broadcasting station and that includes AV streams of a plurality of channels. The digital broadcasting receiving apparatus 1 displays, on a display 10, programs, commercial messages, or the like of the respective channels corresponding to the AV streams acquired from the received digital broadcasting signal.

In addition, as shown in FIG. 1, the digital broadcasting receiving apparatus 1 is allowed to display video of a plurality of channels on a screen at the same time. In the case of the example of FIG. 1, reduced video of the respective channels is displayed on the display 10 in 3×3 matrix form. For example, when this screen is displayed at channel selection, a viewer is allowed to select a desired one of a plurality of programs by operating a remote controller and watch the same.

(Configuration Example of Digital Broadcasting Receiving Apparatus)

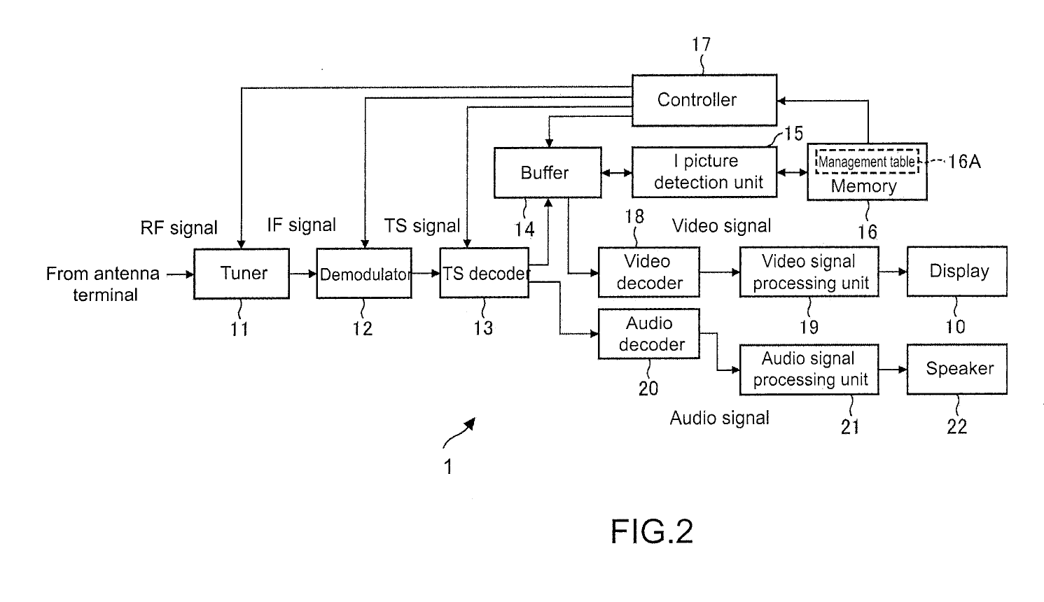

FIG. 2 is a diagram showing a configuration example of the digital broadcasting receiving apparatus 1 in FIG. 1.

Besides the above display 10 (in FIG. 1), the digital broadcasting receiving apparatus 1 includes a tuner 11, a demodulator 12, a TS decoder 13, a buffer 14, an I picture detection unit 15, a memory 16, a controller 17, a video decoder 18, a video signal processing unit 19, an audio decoder 20, an audio signal processing unit 21, and a speaker 22.

To the tuner 11, supplied is a digital broadcasting signal (RF (Radio Frequency) signal) received by an antenna (not shown). The tuner 11 frequency-converts the RF signal supplied from the antenna into an IF (Intermediate Frequency) signal and then supplies the IF signal to the demodulator 12.

The demodulator 12 applies predetermined demodulation processing to the IF signal supplied from the tuner 11 and then supplies a resulting TS (Transport Stream) signal to the TS decoder 13.

The TS decoder 13 divides the TS signal supplied from the demodulator 12 into a video stream signal and an audio stream signal. The TS decoder 13 supplies the divided video stream signal to the buffer 14 and the divided audio stream signal to the audio decoder 20.

The buffer 14 successively stores, under the control of the controller 17, the video stream signals supplied from the TS decoder 13.

The I picture detection unit 15 detects Intra-coded pictures (hereinafter referred to as I pictures) contained in the video stream signals stored in the buffer 14. The I picture detection unit 15 acquires, using the detected I pictures, decoding control information as information used to control decoding, and then registers the decoding control information in a management table 16A that is stored in the memory 16 and used to manage the decoding control information.

The decoding control information contains at least time information on the I pictures, a stream ID (identification information) used to identify the video stream signal from which the I pictures have been detected, and address information in the buffer 14 on the detected I pictures.

The controller 17 controls decoding of the video stream signals performed by the video decoder 18.

More specifically, based on the decoding control information registered in the management table 16A stored in the memory 16, the controller 17 supplies the video stream signals stored in the buffer 14 to the video decoder 18 such that decoding is successively performed in the order of time positions from the video stream signal containing the I picture located in the front position as a relative time position among the I pictures detected for the respective channels.

The video decoder 18 decodes the video stream signals supplied from the buffer 14 and then supplies resulting video signals to the video signal processing unit 19.

The video signal processing unit 19 performs predetermined signal processing in which the video signals for the respective channels supplied from the video decoder 18 are resized to combine video of the plurality of channels together so as to be displayed on the screen, and then supplies a resulting video signal to the display 10. The display 10 displays the screen of the video of the plurality of channels corresponding to the video signal supplied from the video signal processing unit 19.

Note that a detailed configuration of the video signal processing unit 19 will be described below.

The audio decoder 20 decodes the audio stream signal supplied from the TS decoder 13 and then supplies a resulting audio signal to the audio signal processing unit 21.

The audio signal processing unit 21 applies predetermined signal processing to the audio signal supplied from the audio decoder 20 and then supplies a resulting audio signal to the speaker 22. The speaker 22 outputs sound corresponding to the audio signal supplied from the audio signal processing unit 21.

The digital broadcasting receiving apparatus 1 is thus configured.

(Detailed Configuration Example of Video Signal Processing Unit)

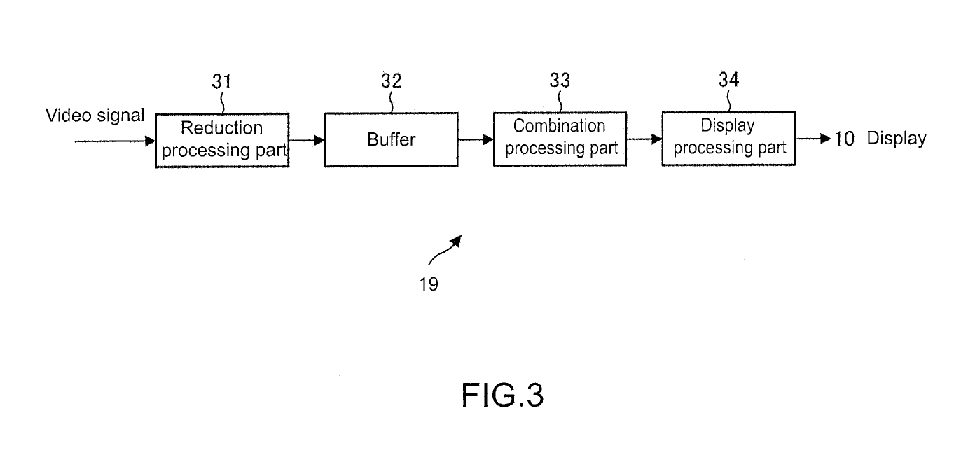

FIG. 3 is a diagram showing a detailed configuration example of the video signal processing unit 19 in FIG. 2.

The video signal processing unit 19 includes a reduction processing part 31, a buffer 32, a combination processing part 33, and a display processing part 34.

To the reduction processing part 31, supplied are video signals from the video decoder 18. The reduction processing part 31 applies resizing processing for reducing the size of video to the video signals corresponding to respective channels, and then successively stores resulting video signals in the buffer 32.

In the buffer 32 the video signals having undergone the resizing processing by the reduction processing part 31 are successively stored for the respective channels.

When the video signals having undergone the resizing processing are stored in the buffer 32 for all the channels, the combination processing part 33 reads the video signals stored in the buffer 32. The combination processing part 33 combines together the video signals that are read from the buffer 32 and correspond to the respective channels, and then supplies a resulting video signal to the display processing part 34.

The display processing part 34 displays, on the display 10, a screen of the video of the plurality of channels corresponding to the video signal supplied from the combination processing part 33.

The video signal processing unit 19 is thus configured.

(Processing for Displaying Video of Plurality of Channels on Screen)

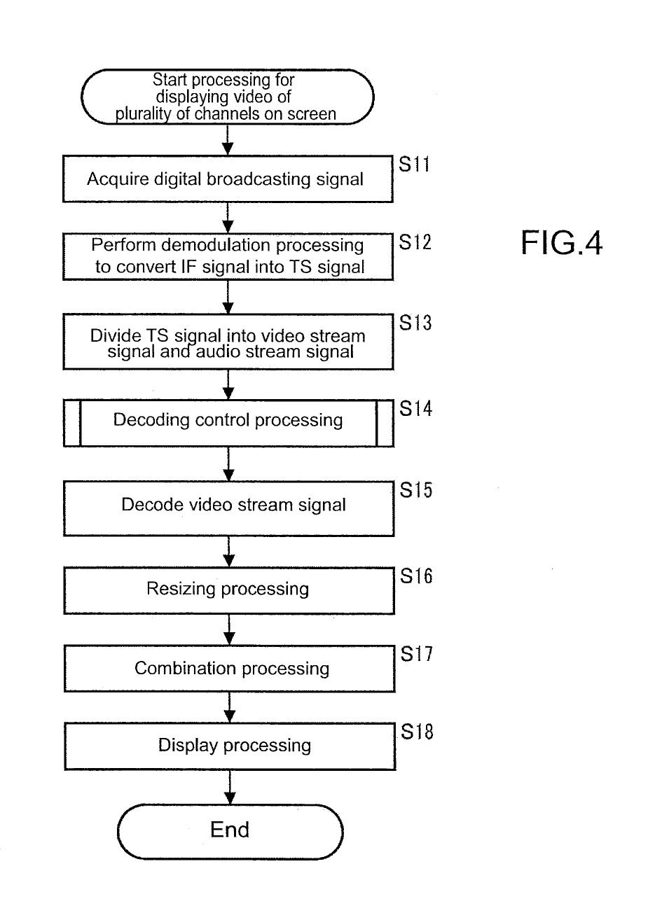

Next, processing for displaying video of a plurality of channels on a screen will be described with reference to a flowchart in FIG. 4.

In step S11, the tuner 11 acquires a digital broadcasting signal (RF signal) received by an antenna (not shown). The tuner 11 frequency-converts the RF signal into an IF signal and then supplies the IF signal to the demodulator 12.

In step S12, the demodulator 12 applies predetermined demodulation processing to the IF signal supplied from the tuner 11 and then supplies a resulting TS signal to the TS decoder 13.

In step S13, the TS decoder 13 divides the TS signal supplied from the demodulator 12 into a video stream signal and an audio stream signal.

In step S14, the buffer 14, the I picture detection unit 15, the memory 16, and the controller 17 perform decoding control processing. With the decoding control processing, video stream signals to be decoded by the video decoder 18 are successively supplied to the video decoder 18 in the order of the time positions of I pictures detected for the respective channels.

Note that the decoding control processing will be described in detail below.

In step S15, the video decoder 18 successively decodes the video stream signals supplied from the buffer 14 and then supplies resulting video signals to the reduction processing part 31.

In step S16, the reduction processing part 31 applies resizing processing to the video signals that are supplied from the video decoder 18 and correspond to the respective channels, and then successively stores resulting video signals in the buffer 32. As a result, in the buffer 32, the video signals having undergone the resizing processing are successively stored for the respective channels.

In step S17, the combination processing part 33 combines together the video signals that are read from the buffer 32 and correspond to the respective channels, and then supplies a resulting video signal to the display processing part 34.

In step S18, the display processing part 34 displays, on the display 10, the screen of the video of the plurality of channels corresponding to the video signal supplied from the combination processing part 33. Thus, as shown in FIG. 1, on the display 10, the video of the plurality of channels is displayed on the screen at the same time.

The description of the processing for displaying video of the plurality of channels on the screen is thus finished. (Detailed Description of Decoding Control Processing)

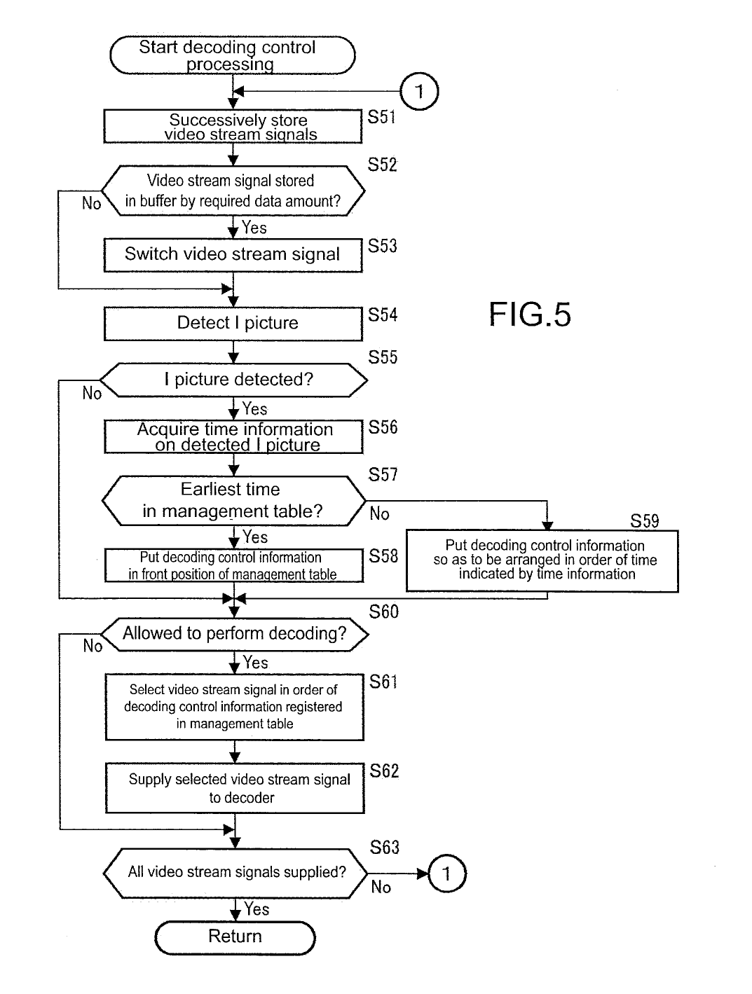

Next, the decoding control processing corresponding to the processing of step S14 in FIG. 4 will be described in detail with reference to a flowchart in FIG. 5.

In step S51, the buffer 14 successively stores the video stream signals supplied from the TS decoder 13.

In step S52, the controller 17 determines whether the video stream signal has been stored in the buffer 14 by a minimum data amount with which the video decoder 18 is allowed to perform decoding.

In step S52, if it is determined that the video stream signal has been stored in the buffer 14 by the necessary data amount, the processing proceeds to step S53. In step S53, the controller 17 controls the tuner 11, the demodulator 12, and the TS decoder 13 to switch the video stream signal to be stored in the buffer 14.

In this manner, the video stream signals for respective channels are successively stored in the buffer 14 by the data amount necessary for decoding.

On the other hand, in step S52, if it is determined that the video stream signal has not been stored in the buffer 14 by the necessary data amount, the processing skips step S53 and proceeds to step S54.

In step S54, the I picture detection unit 15 detects an I picture contained in the video stream signal for each of the channels stored in the buffer 14.

In step S55, the I picture detection unit 15 determines whether the I picture has been detected from the video stream signal. In step S55, if it is determined that the I picture has been detected, the processing proceeds to step S56.

In step S56, the I picture detection unit 15 acquires time information on the detected I picture from the video stream signal stored in the buffer 14.

The time information on the I picture is acquired from, for example, a DTS (Decoding Time Stamp) or a PTS (Presentation Time Stamp) defined by MPEG-2TS. Here, the DTS represents the time at which a video stream signal is decoded. Further, the PTS represents the time at which a video signal acquired by decoding is displayed. With the DTS or PTS, the relationship between the relative time positions of the I pictures detected for the respective channels may be specified.

In step S57, the I picture detection unit 15 determines, referring to the management table 16A stored in the memory 16, whether the time indicated by the time information on the acquired I picture is the earliest one among those indicated by the time information in the management table 16A.

In step S57, if it is determined that the time is the earliest one among those in the management table 16A, the processing proceeds to step S58. In step S58, the I picture detection unit 15 acquires identification information and address information on the detected I picture and puts decoding control information containing such information in the front position of the management table 16.

On the other hand, in step S57, if it is determined that the time is not the earliest one among those in the management table 16A, the processing proceeds to step S59.

In step S59, the I picture detection unit 15 acquires the identification information and the address information on the detected I picture and puts the decoding control information containing such information in the management table 16 so as to be arranged in the order of the time indicated by the time information.

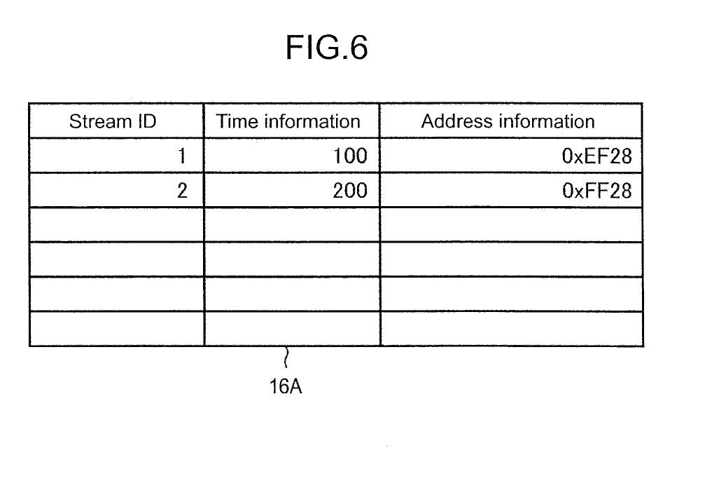

FIG. 6 is a diagram showing an example of the management table 16A.

The management table 16A has the items of stream IDs, time information, and address information corresponding to decoding control information. Note that the time information is expressed in the unit of, for example, seconds.

In the example of FIG. 6, an I picture is detected from a video stream signal 1 (stream ID=“1”), and corresponding time information “100” and address information “0xEF28” are registered in the management table 16A. Further, an I picture is detected from a video stream signal 2 (stream ID=“2”), and corresponding time information “200” and address information “0xFF28” are registered in the management table 16A. The decoding control information on the video stream signal 1 and the video stream signal 2 is arranged in the order of the time indicated by the time information.

Here, if an I picture is detected from a video stream signal 3 (stream ID=“3”) and corresponding time information is “150,” the time information is positioned between the time information “100” and “200.” Therefore, the decoding control information on the video stream signal 3 is put between the decoding control information on the video stream signal 1 (stream ID=“1”) and the decoding control information on the video stream signal 2 (stream ID=“2”).

Further, if an I picture is detected from a video stream signal 4 (stream ID=“4”) and corresponding time information is “250,” the time information is positioned after the time information “100,” “150,” and “200.” Therefore, the decoding control information on the video stream signal 4 is put in the last row of the management table 16A.

In other words, for example, in a case where the I pictures are detected from the respective video stream signals 1 to 4 and the decoding control information on the video stream signals 1 to 4 is registered in the management table 16A, the decoding control information is sorted in ascending order based on the time information and rearranged in the order of the video stream signals 1, 3, 2, and 4.

Note that if an I picture is detected from a video stream signal and corresponding time information is “50,” the decoding control information on the video stream signal is put in the front position of the management table 16A.

Referring back to the flowchart in FIG. 5, when the decoding control information is registered in the management table 16A in step S58 or step S59, the processing proceeds to step S60.

Further, if it is determined in step S55 that no I picture has been detected, the processing skips steps S56 to S59 and proceeds to step S60.

In step S60, the controller 17 determines whether the video decoder 18 is allowed to perform decoding.

If it is determined in step S60 that the video decoder 18 is allowed to perform decoding, the processing proceeds to step S61. In step S61, the controller 17 selects, referring to the management table 16A stored in the memory 16, the video stream signal corresponding to a stream ID in the order of the decoding control information registered in the management table 16A. In short, the video stream signal having the earliest time is first selected in the order of the time indicated by the time information.

In step S62, the controller 17 supplies the video stream signal selected in the processing of step S61 from the buffer 14 to the video decoder 18.

Accordingly, the video decoder 18 decodes the video stream signal supplied from the buffer 14.

On the other hand, if it is determined in step S60 that the video decoder 18 is not allowed to perform decoding, the processing skips steps S61 and S62 and proceeds to step S63.

In step S63, the controller 17 determines whether all the video stream signals have been supplied to the video decoder 18.

If it is determined in step S63 that all the video stream signals have not been supplied to the video decoder 18, the processing returns to step S51 to repeatedly perform the subsequent processing.

In other words, when the processing subsequent to step S51 is repeatedly performed, the video stream signals for the respective channels are successively stored in the buffer 14 and the I pictures contained in the video stream signals stored in the buffer 14 are detected at the same time. Then, when the I pictures are detected, the decoding control information on the video stream signals is registered in the management table 16A in the order of the time indicated by corresponding time information. Further, at the same time, if the video decoder 18 is allowed to perform decoding, the video stream signals stored in the buffer 14 are successively supplied to the video decoder 18 in the order of the decoding control information registered in the management table 16A.

After that, when it is determined in step S63 that all the video stream signals have been supplied to the video decoder 18, the decoding control processing in FIG. 5 is finished and then the processing returns to step S14 in FIG. 4 to perform the subsequent processing.

The description of the decoding control processing is thus finished.

In the above decoding control processing, a digital broadcasting signal including AV streams of a plurality of channels is received by the tuner 11, video stream signals acquired from the received digital broadcasting signal are stored in the buffer 14, I pictures contained in the video stream signals stored in the buffer 14 are detected for the respective channels by the I picture detection unit 15, and decoding control information on the video stream signals is registered in the management table 16A.

Then, the controller 17 controls, based on the decoding control information registered in the management table 16A, decoding of the video stream signals in such a manner as to be successively performed in the order of time positions from the video stream signal containing the I picture located in the front position as a relative time position among the I pictures detected for the respective channels. Accordingly, the video decoder 18 is allowed to perform decoding in the order from the video stream signal containing the I picture located in the front position as a relative time position among the I pictures detected for the respective channels. As a result, it is possible to display video of the plurality of channels on a screen with the shortest time.

(Processing Time When Decoding Control Processing is Performed)

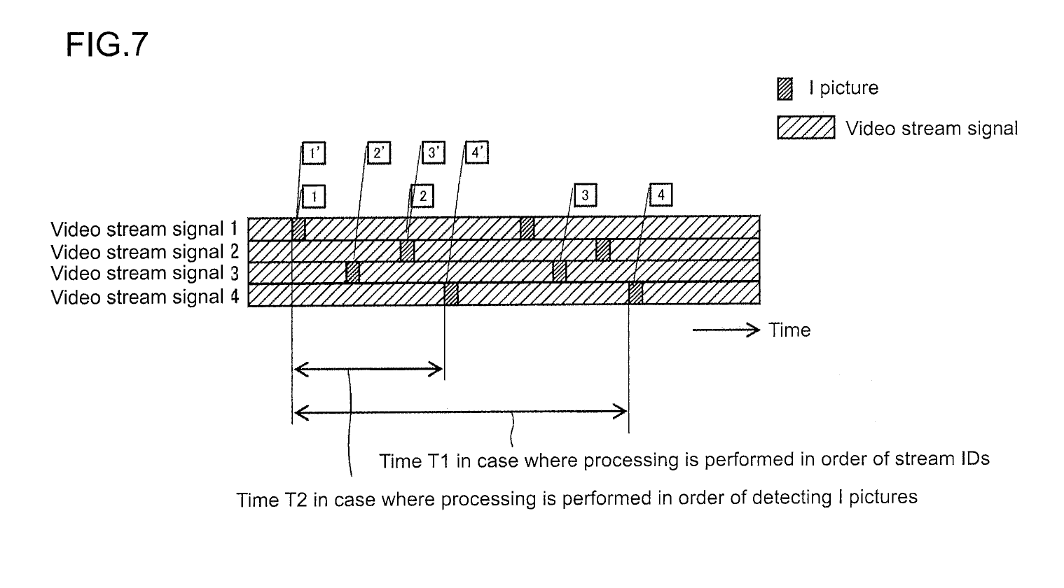

FIG. 7 is a diagram for explaining processing time when the decoding control processing is performed.

FIG. 7 schematically shows the case in which video stream signals 1 to 4 (stream IDs 1 to 4) are stored in the buffer 14. Note that time flows from the left to the right in FIG. 7.

As shown in FIG. 7, I pictures are arranged at any positions of the video stream signals, but numbers assigned to the I pictures in FIG. 7 indicate the order of detecting the I pictures. More specifically, the digital broadcasting receiving apparatus 1 is not allowed to recognize the arrangement of the I pictures. Therefore, in a case where the processing is performed in the order of the stream IDs, the I pictures are detected in the order of the stream IDs 1, 2, 3, and 4, and thus time T1 is necessary as processing time.

On the other hand, in a case where the processing is performed in the order of detecting the I pictures, the I pictures are detected in the order of 1′, 2′, 3′, and 4′ regardless of the order of the stream IDs, and thus time T2 is necessary as processing time. More specifically, with the decoding control processing in FIG. 5, the video stream signals are successively supplied to the video decoder 18 in the order of detecting the I pictures. For example, it is possible to detect the I picture located in the front position of the video stream signal 3 prior to the I picture located in the front position of the video stream signal 2.

Conversely, in a case where the I pictures are detected in the order of the stream IDs, detection of the I picture of the video stream signal 3 is not allowed unless the I picture of the video stream signal 2 is detected. Therefore, although the I picture located in the front position of the video stream signal 3 is ahead of the I picture located in the front position of the video stream signal 2, the detection of the I picture of the video stream signal 3 is not allowed.

As described above, with the decoding control processing in FIG. 5, the processing time for detecting the I pictures is reduced from, for example, the time T1 to the time T2. As a result, it is possible to reduce time for displaying video of a plurality of channels on a screen and quickly display the same.

In this case, although the reduced video of the respective channels is randomly displayed on the screen in the order of detecting the I pictures, reduction in time for displaying the entire screen is made possible.

Note that in the above description, an example of the digital broadcasting receiving apparatus includes a television receiver but is not limited to a single body. For example, the function of the digital broadcasting receiving apparatus may be included in a video recorder or the like.

(Configuration Example of Computer)

Meanwhile, the above series of processing may be performed not only by hardware but also by software. When the series of processing is performed by software, a program configuring the software is installed, via a program recording medium, in a computer incorporated in dedicated hardware, a general-purpose personal computer capable of performing various functions with the installation of various programs, or the like.

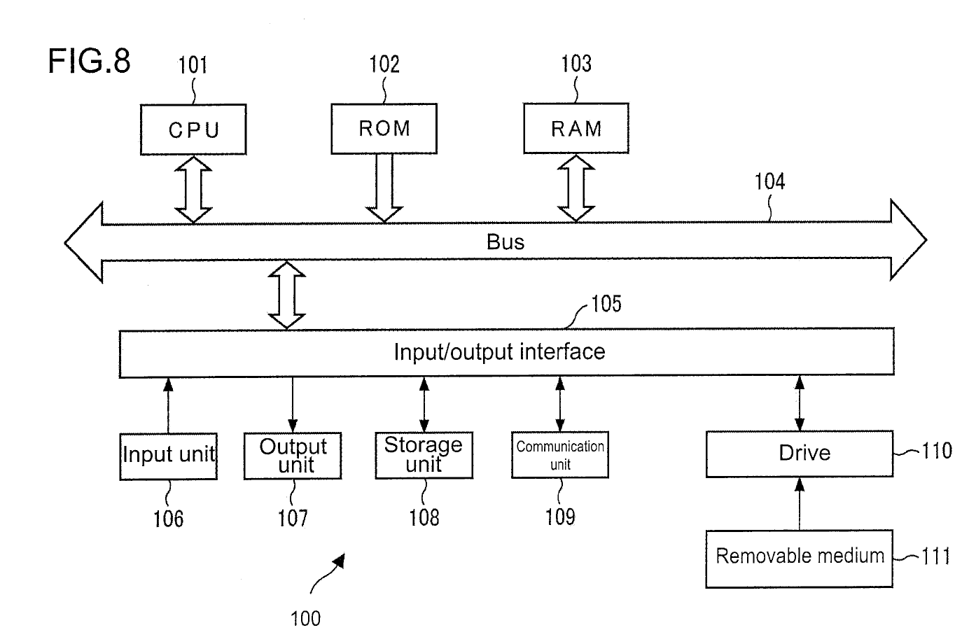

FIG. 8 is a diagram showing a configuration example of the hardware of a computer that performs the above series of processing according to a program.

In the computer 100, a CPU (Central Processing Unit) 101, a ROM (Read Only Memory) 102, and a RAM (Random Access Memory) 103 are connected to one another via a bus 104.

Furthermore, the bus 104 is connected to an input/output interface 105. The input/output interface 105 is connected to an input unit 106, an output unit 107, a storage unit 108, a communication unit 109, and a drive 110. The input unit 106 includes a keyboard, a mouse, a microphone, and the like. The output unit 107 includes a display, a speaker, and the like. The storage unit 108 includes a hard disk, a non-volatile memory, and the like.

The communication unit 109 includes a network interface and the like. The drive 110 drives a removable medium 111 such as a magnetic disk, an optical disk, a magnetic optical disk, and a semiconductor memory.

In the computer 100 thus configured, for example, the CPU 101 loads the program stored in the storage unit 108 into the RAM 103 via the input/output interface 105 and the bus 104, and executes the same to perform the above series of processing.

Note that the program executed by the computer 100 may be a program in which the processing is performed chronologically in the order described herein or may be a program in which the processing is performed in parallel or at an appropriate timing such as when invoking is performed.

Further, the program may be processed by a single computer or may be processed by a plurality of computers in a distributed manner. Moreover, the program may be transferred to and executed by a remote computer.

Furthermore, the embodiment of the present disclosure is not limited to the above embodiment, and various modifications may be made without departing from the spirit of the present disclosure.

Note that the present disclosure may employ the following configurations.

(1) A receiving apparatus, including:

a receiving unit configured to receive a digital broadcasting signal including AV (audio/video) streams of a plurality of channels;

a buffer configured to store video stream signals acquired from the received digital broadcasting signal;

an I (Intra-coded) picture detection unit configured to detect I pictures contained in the stored video stream signals; and

a decoding control unit configured to control decoding of the video stream signals in such a manner as to be successively performed in an order of time positions from the video stream signal containing the I picture located in a front position as a relative time position among the I pictures detected for the respective channels.

(2) The receiving apparatus according to (1), further including:

a storage unit configured to store a table storing time information on the relative time positions of the I pictures detected for the respective channels, in which

the decoding control unit is configured to control, based on the time information stored in the table, an order of decoding the video stream signals for the respective channels.

(3) The receiving apparatus according to (2), in which

the time positions are specified by a DTS (Decoding Time Stamp) or a PTS (Presentation Time Stamp).

(4) The receiving apparatus according to (2) or (3), in which

the table is configured to store, as decoding control information for the respective channels, at least the time information, identification information used to identify the video stream signals, and address information on the I pictures stored in the buffer.

(5) The receiving apparatus according to (1) to (4), in which

the decoding control unit is configured to switch, when the video stream signal of a predetermined one of the channels is stored in the buffer by a data amount with which the decoding is allowed to be performed, the video stream signal to be stored in the buffer to the video stream signal of another of the channels.

(6) The receiving apparatus according to (1) to (5), further including:

a decoder configured to decode the video stream signals supplied from the buffer; and

an image processing unit configured to resize video signals of the respective channels acquired by decoding the video stream signals to combine video of the channels together so as to be displayed on a screen.

(7) A receiving method of a receiving apparatus, the receiving method including:

receiving a digital broadcasting signal including AV streams of a plurality of channels;

storing video stream signals acquired from the received digital broadcasting signal;

detecting I pictures contained in the stored video stream signals; and

controlling decoding of the video stream signals in such a manner as to be successively performed in an order of time positions from the video stream signal containing the I picture located in a front position as a relative time position among the I pictures detected for the respective channels.

(8) A program controlling a receiving apparatus and causing a computer of the receiving apparatus to perform a receiving method of the receiving apparatus, the receiving method including:

receiving a digital broadcasting signal including AV streams of a plurality of channels;

storing video stream signals acquired from the received digital broadcasting signal;

detecting I pictures contained in the stored video stream signals; and

controlling decoding of the video stream signals in such a manner as to be successively performed in an order of time positions from the video stream signal containing the I picture located in a front position as a relative time position among the I pictures detected for the respective channels.

The present disclosure contains subject matter related to that disclosed in Japanese Priority Patent Application JP 2011-142505 filed in the Japan Patent Office on Jun. 28, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A receiving apparatus, comprising:
a receiving unit configured to receive a digital broadcasting signal including AV (audio/video) streams of a plurality of channels;
a buffer configured to store video stream signals acquired from the received digital broadcasting signal;
an I (Intra-coded) picture detection unit configured to detect I pictures contained in the stored video stream signals; and
a decoding control unit configured to control decoding of the video stream signals in such a manner as to be successively performed in an order of time positions from the video stream signal containing the I picture located in a front position as a relative time position among the I pictures detected for the respective channels.

2. The receiving apparatus according to claim 1, further comprising:
a storage unit configured to store a table storing time information on the relative time positions of the I pictures detected for the respective channels, wherein
the decoding control unit is configured to control, based on the time information stored in the table, an order of decoding the video stream signals for the respective channels.

3. The receiving apparatus according to claim 2, wherein
the time positions are specified by one of a DTS (Decoding Time Stamp) and a PTS (Presentation Time Stamp).

4. The receiving apparatus according to claim 2, wherein
the table is configured to store, as decoding control information for the respective channels, at least the time information, identification information used to identify the video stream signals, and address information on the I pictures stored in the buffer.

5. The receiving apparatus according to claim 1, wherein
the decoding control unit is configured to switch, when the video stream signal of a predetermined one of the channels is stored in the buffer by a data amount with which the decoding is allowed to be performed, the video stream signal to be stored in the buffer to the video stream signal of another of the channels.

6. The receiving apparatus according to claim 1, further comprising:
a decoder configured to decode the video stream signals supplied from the buffer; and
an image processing unit configured to resize video signals of the respective channels acquired by decoding the video stream signals to combine video of the channels together so as to be displayed on a screen.

7. A receiving method of a receiving apparatus, the receiving method comprising:
receiving a digital broadcasting signal including AV streams of a plurality of channels;
storing video stream signals acquired from the received digital broadcasting signal;
detecting I pictures contained in the stored video stream signals; and
controlling decoding of the video stream signals in such a manner as to be successively performed in an order of time positions from the video stream signal containing the I picture located in a front position as a relative time position among the I pictures detected for the respective channels.

8. A program for controlling a receiving apparatus, the program causing a computer of the receiving apparatus to perform processing including the steps of:
receiving a digital broadcasting signal including AV streams of a plurality of channels;
storing video stream signals acquired from the received digital broadcasting signal;
detecting I pictures contained in the stored video stream signals; and
controlling decoding of the video stream signals in such a manner as to be successively performed in an order of time positions from the video stream signal containing the I picture located in a front position as a relative time position among the I pictures detected for the respective channels.
